(19) United States
(12) Patent Application Publication
(10) Pub. No.: US 2016/0297305 A1
(43) Pub. Date: Oct. 13, 2016

(54) POWER TRANSMITTING DEVICE, AND POWER TRANSFER SYSTEM

(71) Applicant: TOYOTA JIDOSHA KABUSHIKI KAISHA, Toyota-shi, Aichi-ken (JP)

(72) Inventor: Shinji ICHIKAWA, Toyota-shi (JP)

(73) Assignee: TOYOTA JIDOSHA KABUSHIKI KAISHA, Toyota-shi, Aichi-ken (JP)

(21) Appl. No.: 15/102,028

(22) PCT Filed: Dec. 10, 2014
(86) PCT No.: PCT/IB2014/002712

§ 371 Date: Jun. 6, 2016

(30) Foreign Application Priority Data
Dec. 13, 2013 (JP) 2013-258079

(51) Int. Cl. B60L 11/18

(52) U.S. Cl. CPC B60L 11/182; B60L 11/1831

(57) ABSTRACT

A power transfer system, including a vehicle and a power transmitting device, and the power transmitting device are provided. The power transmitting device is configured to contactlessly transmit electric power to a vehicle on which a power receiving coil having any one of a plurality of different coil types is mounted. The power transmitting device includes a plurality of power transmitting coils and an electronic control unit (ECU). The ECU is configured to control currents that are respectively supplied to the plurality of power transmitting coils. The ECU is configured to select at least two power transmitting coils from among the plurality of power transmitting coils based on the coil type of the vehicle that serves as a power transmitted target and to set directions of currents respectively flowing through the selected at least two power transmitting coils.

### BACKGROUND OF THE INVENTION

1. Field of the Invention

The invention relates to a power transmitting device and a power transfer system.

2. Description of Related Art

International Application Publication No. WO2011/016736 describes various coil shapes that are used in a contactless charging system that contactlessly transfers electric power. When a power receiving coil for contactless charging is mounted on a vehicle, it is assumed that such various coils are mounted.

In contactless charging, it is important to align the position of a power transmitting coil with the position of a power receiving coil in order to increase a transfer efficiency. However, it is not easy for a power transmitting device to adapt to vehicles on which power receiving coils having various coil shapes are respectively mounted. Even when the coil shapes of the power receiving coils of vehicles are the same, it is presumable that mounting positions of the power receiving coils can be different from each other. If the shape of the power receiving coil of a vehicle is different from the shape of the power transmitting coil of a power transmitting device, the power transfer efficiency may decrease. Depending on a vehicle mounting position, a distance between the power transmitting coil and the power receiving coil significantly varies at the time when the vehicle stops, with the result that there is a concern that the power transfer efficiency decreases.

### SUMMARY OF THE INVENTION

The invention provides a power transmitting device and a power transfer system that are adaptable to various vehicles.

An aspect of the invention provides a power transmitting device. The power transmitting device is configured to contactlessly transmit electric power to a vehicle on which a power receiving coil having any one of a plurality of different coil types is mounted. The power transmitting device includes a plurality of power transmitting coils and an electronic control unit. Each of the plurality of power transmitting coils is configured such that a coil wire is wound so as to surround a corresponding one of winding axes extending in a vertical direction. The plurality of power transmitting coils are arranged in a vehicle traveling direction or vehicle width direction of a parking space. The plurality of power transmitting coils are configured to contactlessly transmit electric power to the power receiving coil. The electronic control unit is configured to control currents that are respectively supplied to the plurality of power transmitting coils. The electronic control unit is configured to transmit electric power from the power transmitting coils to the power receiving coil based on a characteristic of the power receiving coil mounted on the vehicle that serves as a power transmitted target.

With the above power transmitting device, electric power is transmitted from the power transmitting coils to the power receiving coil by appropriately adapting the power transmitting coils to the characteristic of the power receiving coil mounted on the vehicle that serves as the power transmitted target. Thus, it is possible to transmit electric power while suppressing a decrease in power transfer efficiency.

The power receiving coil may have the any one of the plurality of different coil types. The electronic control unit may be configured to select at least two power transmitting coils from among the power transmitting coils based on of the coil type of the power receiving coil. The coil type of the power receiving coil may be the characteristic of the power receiving coil of the vehicle that serves as the power transmitted target. The electronic control unit may be configured to set directions of currents respectively flowing through the selected at least two power transmitting coils.

With the above configuration, it is possible to transmit electric power to the vehicle on which the power receiving coil having any one of various coil types, such as solenoid type, spiral type and DD type (described later), is mounted.

In the power transmitting device, the plurality of coil types may include a first coil type and a second coil type. The first coil type may be configured such that a coil wire is wound so as to surround a winding axis extending in a horizontal direction. The second coil type may be configured such that two coils in each of which a coil wire is wound so as to surround a corresponding one of winding axes extending in the vertical direction are arranged side by side in the horizontal direction. The electronic control unit may be configured to, when the coil type of the power receiving coil of the vehicle that serves as the power transmitted target is the first coil type or the second coil type, pass currents respectively through the selected two power transmitting coils such that directions of magnetic fluxes that are respectively generated at the corresponding winding axes of the selected two power transmitting coils are opposite to each other.

With the above configuration, particularly, it is possible to transmit electric power to a vehicle on which a solenoid coil or a DD coil (described later) is mounted.

In the power transmitting device, the electronic control unit may be configured to change the power transmitting coils to be selected in response to a mounting position of the power receiving coil in the vehicle, the mounting position of the power receiving coil may be the characteristic of the power receiving coil.

With the above configuration, it is possible to transmit electric power to a vehicle having a different mounting position of the power receiving coil.

In the power transmitting device, the electronic control unit may be configured to adjust a distance between the two power transmitting coils to be selected in response to a size of the power receiving coil by changing the power transmitting coils to be selected, the size of the power receiving coil may be the characteristic of the power receiving coil.

With the above configuration, it is possible to transmit electric power to a vehicle having a different size of the power receiving coil.

In the power transmitting device, the power receiving coil may be mounted at any one of a plurality of different mounting positions of the vehicle. The electronic control unit may be configured to select the power transmitting coils in response to the mounting position of the power receiving coil in the vehicle, the mounting position of the power receiving coil may be the characteristic of the power receiving coil of the vehicle that serves as the power transmitted target.

With the above configuration, it is possible to transmit electric power to a vehicle having a different mounting position of the power receiving coil.

In the power transmitting device, the power receiving coil of the vehicle may be any one of power receiving coils respectively having a plurality of different sizes. The electronic control unit may be configured to select at least two power transmitting coils from among the plurality of power transmitting coils. The electronic control unit may be configured to adjust a distance between the two power transmitting coils to be selected in response to the size of the power receiving coil by changing the power transmitting coils to be selected, the size of the power receiving coil may be the characteristic of the power receiving coil of the vehicle that serves as the power transmitted target.

With the above configuration; it is possible to transmit electric power to a vehicle having a different size of the power receiving coil.

Another aspect of the invention provides a power transfer system configured to contactlessly transmit or receive electric power. The power transfer system includes a vehicle and a power transmitting device. A power receiving coil having any one of a plurality of different coil types is mounted on the vehicle. The power transmitting device is configured to contactlessly transmit electric power to the power receiving coil of the vehicle. The power transmitting device includes a plurality of power transmitting coils and an electronic control unit. Each of the plurality of power transmitting coils is configured such that a coil wire is wound so as to surround a corresponding one of winding axes extending in a vertical direction. The plurality of power transmitting coils are arranged in a vehicle traveling direction or vehicle width direction of a parking space. The electronic control unit is configured to control currents that are respectively supplied to the plurality of power transmitting coils. The electronic control unit is configured to select at least two power transmitting coils from among the plurality of power transmitting coils based on a characteristic of the power receiving coil mounted on the vehicle that serves as a power transmitted target. The electronic control unit is configured to set directions of currents respectively flowing through the selected at least two power transmitting coils.

In the power transfer system, the power receiving coil may have the any one of the plurality of different coil types. The electronic control unit may be configured to control currents that are respectively supplied to the plurality of power transmitting coils. The electronic control unit may be configured to select at least two power transmitting coils from among the power transmitting coils based on the coil type of the power receiving coil. The coil type of the power receiving coil may be the characteristic of the power receiving coil of the vehicle that serves as the power transmitted target. The electronic control unit may be configured to set directions of currents respectively flowing through the selected at least two power transmitting coils.

With the above configuration, it is possible to transmit electric power to a vehicle on which the power receiving coil having any one of various coil types, such as solenoid type, spiral type and DD type (described later), is mounted.

In the power transfer system, the power receiving coil may be mounted at any one of a plurality of different mounting positions of the vehicle. The electronic control unit may be configured to select the power transmitting coils in response to the mounting position of the power receiving coil in the vehicle, the mounting position of the power receiving coil may be the characteristic of the power receiving coil of the vehicle that serves as the power transmitted target.

With the above configuration, it is also possible to transmit electric power to a vehicle having a different mounting position of the power receiving coil.

In the power transfer system, the power receiving coil of the vehicle may be any one of power receiving coils respectively having a plurality of different sizes. The electronic control unit may be configured to adjust a distance between the two power transmitting coils to be selected in response to the size of the power receiving coil by changing the power transmitting coils to be selected, the size of the power receiving coil may be the characteristic of the power receiving coil of the vehicle that serves as the power transmitted target.

With the above configuration, it is possible to transmit electric power to a vehicle having a different size of the power receiving coil.

With the thus configured power transmitting device and power transfer system according to the invention, it is possible to implement the power transmitting device and the power transfer system that appropriately transmit electric power from the power transmitting coils of the power transmitting device to the power receiving coil mounted on the vehicle in accordance with the vehicle including any one of various different power receiving units while suppressing a decrease in power transfer efficiency.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is the overall configuration view of a contactless power transfer system that is one example of an embodiment of the invention;

FIG. 2 is a view that shows a first coil-type (solenoid) coil that is used in a power receiving unit mounted on a vehicle that is included in the contactless power transfer system;

FIG. 3 is a view that shows a second coil-type (DD) coil that is used in the power receiving unit mounted on the vehicle;

FIG. 4 is a view that shows a third coil-type (spiral) coil that is used in the power receiving unit mounted on the vehicle;

FIG. 5 is a view for illustrating the configuration of coils of a power transmitting unit of a power transmitting device that is included in the contactless power transfer system;

FIG. 6 is a view that shows an example in which a solenoid coil is arranged such that the direction of passage of a magnetic flux coincides with the traveling direction of the vehicle (oriented in a Y direction), and that shows arrangement of a power transmitting unit that adapts to the solenoid coil;

FIG. 7 is a view that shows an example in which a solenoid coil is arranged such that the direction of passage of a magnetic flux intersects with the traveling direction of the vehicle at right angles (oriented in an X direction), and that shows arrangement of a power transmitting unit that adapts to the solenoid coil;

FIG. 8 is a view that shows an example in which a DD coil is arranged such that the array direction of two coils coincides with the traveling direction of the vehicle (oriented in the Y direction), and that shows arrangement of the power transmitting unit that adapts to the DD coil;

FIG. 9 is a view that shows an example in which a DD coil is arranged such that the array direction of two coils intersects with the traveling direction of the vehicle at right angles (oriented in the X direction), and that shows arrangement of the power transmitting unit that adapts to the DD coil;

FIG. 10 is a view for illustrating communication about the coil type of the vehicle;

FIG. 11 is a view for illustrating selection of coils and directions of currents in the coils in the power transmitting unit in the case where the power transmitting unit is adapted to the solenoid-type power receiving unit;

FIG. 12 is a view for illustrating selection of coils and directions of currents in the coils in the power transmitting unit in the case where the power transmitting unit is adapted to the DD-type power receiving unit;

FIG. 13 is a plan view (schematic view) of the coils in the power transmitting unit;

FIG. 14 is a cross-sectional view taken along the line XIV-XIV in FIG. 13 in a state where the position of the solenoid-type power receiving unit is aligned with the position of the power transmitting unit;

FIG. 15 is a cross-sectional view taken along the line XIV-XIV in FIG. 13 in a state where the position of the DD-type power receiving unit is aligned with the position of the power transmitting unit;

FIG. 16 is a view for illustrating selection of coils and directions of currents in the coils in the power transmitting unit in the case where the power transmitting unit is adapted to the spiral coil;

FIG. 17 is a cross-sectional view that shows a state where magnetic fluxes are generated in the case where the position of the coil is aligned at the position shown in FIG. 16;

FIG. 18 is a view for illustrating communication about the position of a coil mounted on the vehicle;

FIG. 19 is a view that shows a state where the position of the power receiving coil shown in FIG. 18 is aligned with the position of the power transmitting unit;

FIG. 20 is a view that shows a state where the position of the power receiving coil shown in FIG. 18 is aligned with the position of the power transmitting unit;

FIG. 21 is a view for illustrating communication about the size of a coil that is mounted on the vehicle;

FIG. 22 is a view that shows a state where the position of the coil shown in FIG. 21 is aligned with the position of the power transmitting unit;

FIG. 23 is a view that shows a state where the position of the coil shown in FIG. 21 is aligned with the position of the power transmitting unit;

FIG. 24 is a circuit diagram that shows a first configuration example of a coil selection unit of the power transmitting unit;

FIG. 25 is a circuit diagram that shows a second configuration example of a coil selection unit of the power transmitting unit;

FIG. 26 is a flowchart for illustrating a schematic process that is executed by the vehicle and the power transmitting device at the time when contactless power transfer is carried out;

FIG. 27 is a view that shows coil position classes 1 to 7 within coil-related information;

FIG. 28 is a table that shows what positions the coil position classes 1 to 7 respectively indicate;

FIG. 29 is a view for illustrating a state where coil-related information is transmitted from the vehicle to the power transmitting device via communication;

FIG. 30 is a timing chart that shows changes in transmitting power and received voltage in course of the process of FIG. 26;

FIG. 31 is a timing chart for illustrating an alternative embodiment of a pairing process; and

FIG. 32 is a view that shows an alternative embodiment of the power transmitting unit.

### DETAILED DESCRIPTION OF EMBODIMENTS

Hereinafter, an embodiment of the invention will be described in detail with reference to the accompanying drawings. Like reference numerals denote the same or corresponding portions in the drawings, and the description thereof will not be repeated.

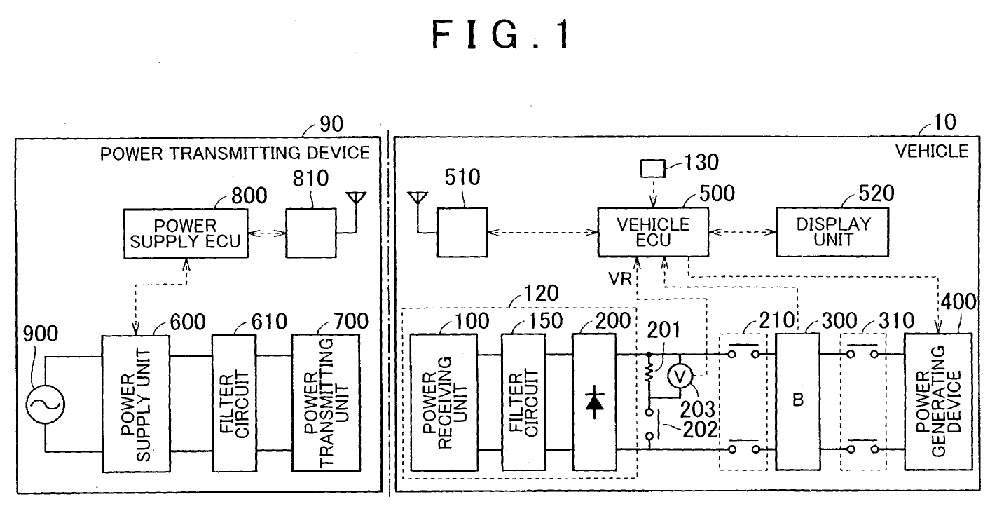

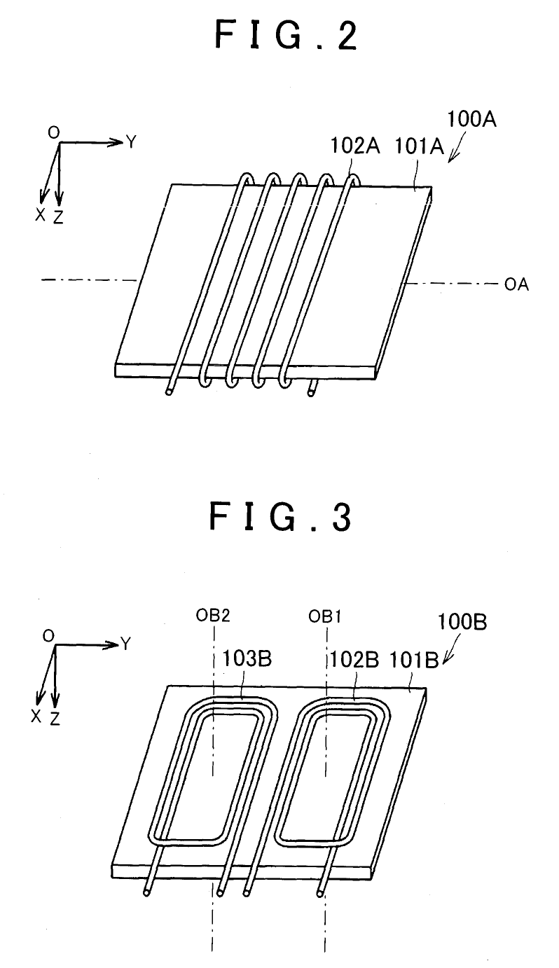

Initially, the outline of a contactless power transfer system will be described. FIG. 1 is the overall configuration view of the contactless power transfer system that is one example of the embodiment of the invention. FIG. 2 to FIG. 4 are views for illustrating the coil types of a power receiving coil of a vehicle that is included in the contactless power transfer system. FIG. 5 is a view that shows the configuration of a power transmitting unit of a power transmitting device that is included in the contactless power transfer system. The outline of the present embodiment will be described with reference to FIG. 1 to FIG. 5, and the like.

The power transmitting device 90 described in the present embodiment is a power transmitting device that is able to contactlessly transmit electric power to a vehicle on which a power receiving coil having any one of a plurality of different coil types (FIG. 2 to FIG. 4) is mounted. As shown in FIG. 5, the power transmitting device 90 includes a plurality of power transmitting coils 701 to 706 and a control unit (power supply ECU 800). Each of the plurality of power transmitting coils 701 to 706 is configured such that a coil wire is wound so as to surround a corresponding one of winding axes O71 to O76 extending in a vertical direction. The plurality of power transmitting coils 701 to 706 are arranged in a vehicle traveling direction or vehicle width direction of a parking space. The control unit (power supply ECU 800) controls currents that are respectively supplied to the plurality of power transmitting coils 701 to 706. The power supply ECU 800 selects at least two power transmitting coils from among the plurality of power transmitting coils 701 to 706 based on the coil type of a vehicle that is a power transmitted target, and sets the directions of currents in the selected power transmitting coils.

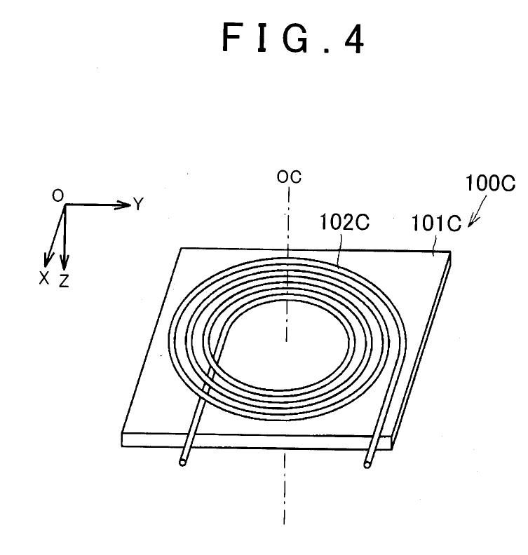

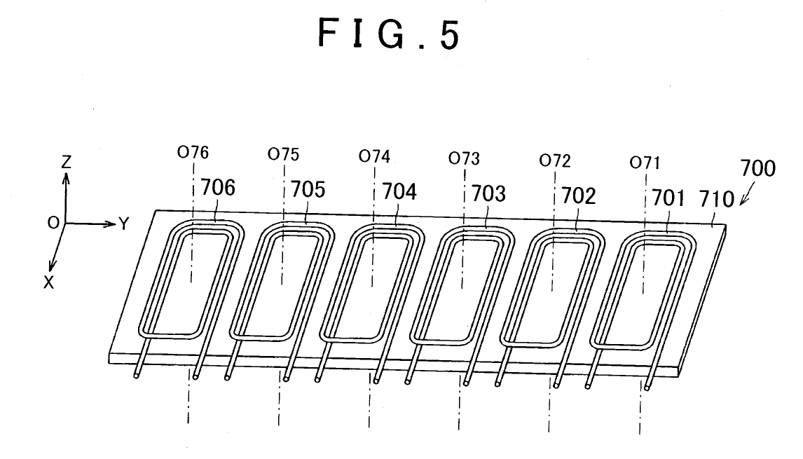

With the above configuration, for example, it is possible to transmit electric power to a vehicle on which any one of various coils, such as solenoid type (FIG. 2), DD type (FIG. 3) and spiral type (FIG. 4), is mounted.

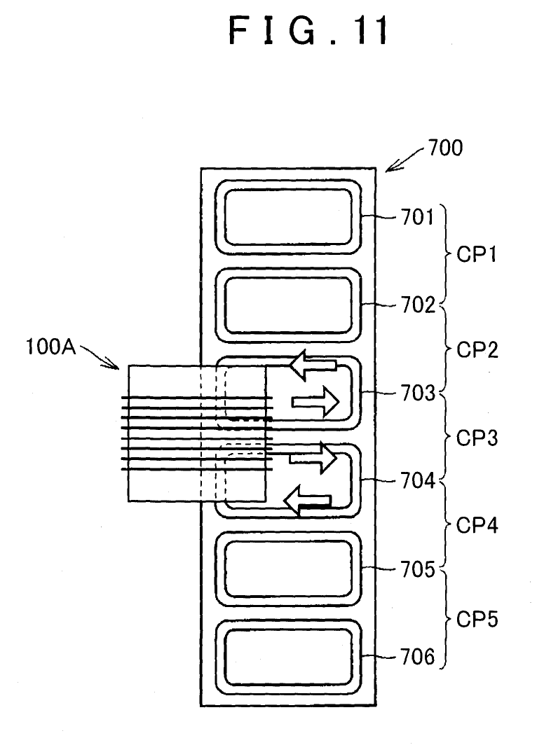

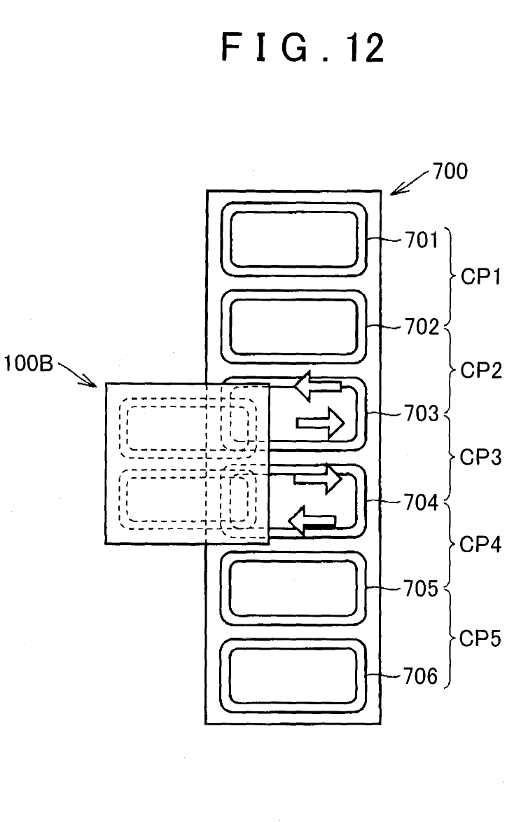

The plurality of coil types include a first coil type (solenoid type) shown in FIG. 2 and a second coil type (DD type) shown in FIG. 3. The first coil type is configured such that a coil wire is wound so as to surround a winding axis OA extending in a horizontal direction. The second coil type is configured such that two coils 102B, 103B in each of which a coil wire is wound so as to surround a corresponding one of winding axes OB1, OB2 extending in the vertical direction are arranged side by side in the horizontal direction. When the coil type of the vehicle that is the power transmitted target is the first coil type or the second coil type, the power supply ECU 800 passes currents respectively through the two power transmitting coils such that directions of magnetic fluxes that are respectively generated at the corresponding winding axes of the selected two power transmitting coils are opposite to each other as shown in FIG. 11 and FIG. 12.

With the above configuration, particularly, it is possible to transmit electric power to a vehicle on which a solenoid coil or a DD coil is mounted.

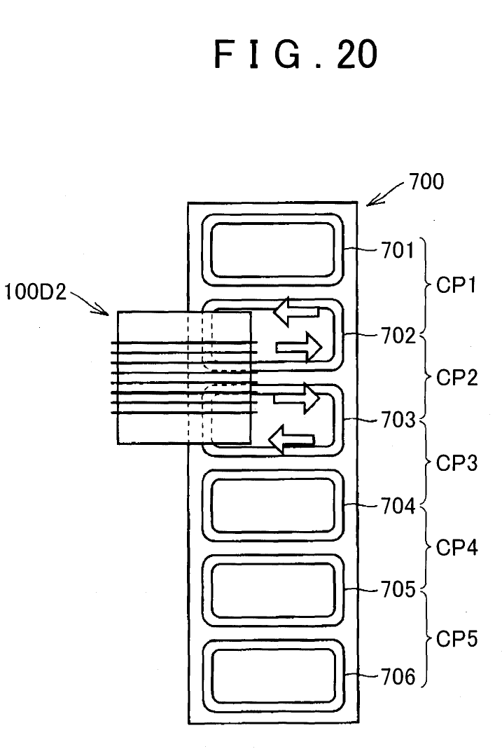

More preferably, as shown in FIG. 19 and FIG. 20, the power supply ECU 800 changes the power transmitting coils to be selected in response to the mounting position of the power receiving coil in the vehicle.

With the above configuration, it is also possible to transmit electric power to a vehicle having a different mounting position of the power receiving coil.

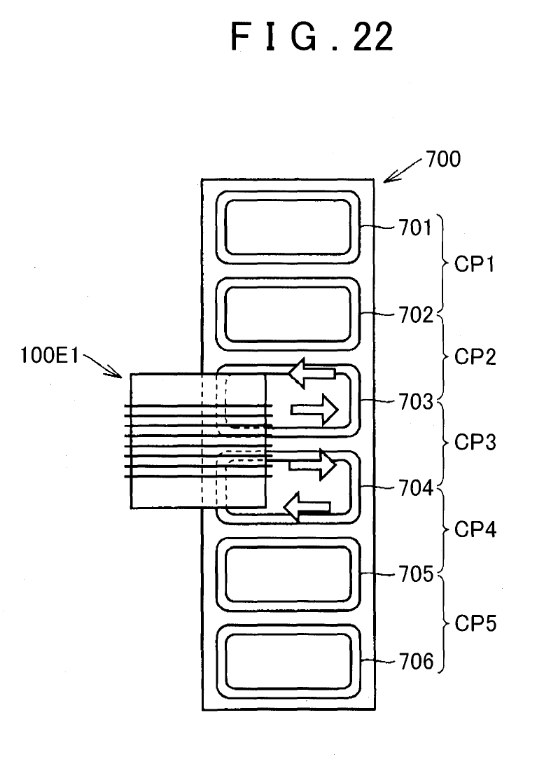

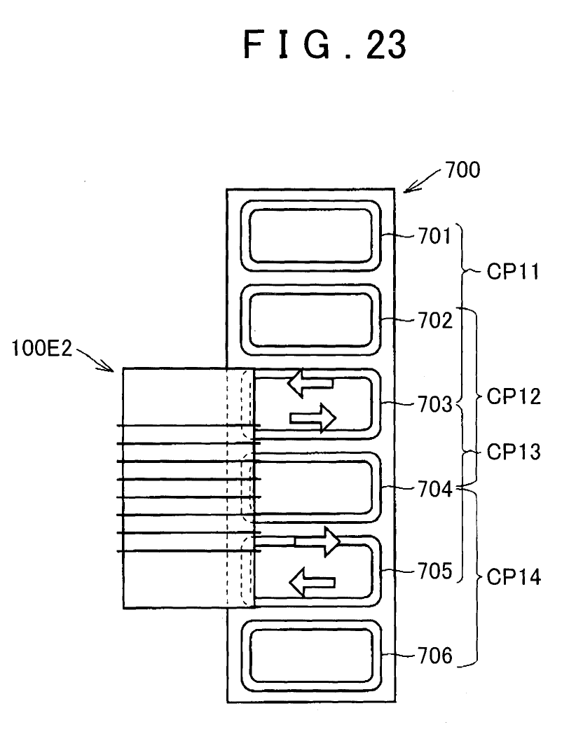

Preferably, as shown in FIG. 22 and FIG. 23, the power supply ECU 800 adjusts the distance between two power transmitting coils to be selected in response to the size of the power receiving coil by changing the power transmitting coils to be selected.

With the above configuration, it is also possible to transmit electric power to a vehicle having a different size of the power receiving coil. Next, the detailed components of the contactless power transfer system will be further described. As shown in FIG. 1, the contactless power transfer system according to the present embodiment includes a vehicle 10 and the power transmitting device 90. A power receiving device 120 is mounted on the vehicle 10, and is configured to be able to contactlessly receive electric power. The power transmitting device 90 transmits electric power to a power receiving unit 100 from the outside of the vehicle.

The vehicle 10 includes the power receiving device 120, a contactless charging switch 130, an electrical storage device 300, a power generating device 400, a communication unit 510, a vehicle ECU 500 and a display unit 520. The power receiving device 120 includes the power receiving unit 100, a filter circuit 150 and a rectifying unit 200.

The power transmitting device 90 includes an external power supply 900, a communication unit 810, the power supply ECU 800, a power supply unit 600, a filter circuit 610 and the power transmitting unit 700.

For example, the power transmitting unit 700 of the power transmitting device is provided on the ground or in the ground of the parking space, and the power receiving device 120 is arranged at the lower portion of a vehicle body. The arrangement location of the power receiving device 120 is not limited to this configuration. For example, if the power transmitting unit 700 is provided above the vehicle 10, the power receiving device 120 may be provided at the upper portion of the vehicle body.

The power receiving unit 100 includes a secondary coil for contactlessly receiving electric power (alternating-current) that is output from the power transmitting unit 700. The power receiving unit 100 outputs received electric power to the rectifying unit 200. The rectifying unit 200 rectifies alternating-current power received by the power receiving unit 100, and outputs the rectified electric power to the electrical storage device 300. The filter circuit 150 is provided between the power receiving unit 100 and the rectifying unit 200, and suppresses harmonic noise that arises upon reception of electric power from the power transmitting unit 700. The filter circuit 150 is, for example, formed of an LC filter including an inductor and a capacitor.

The electrical storage device 300 is a rechargeable direct-current power supply, and is formed of, for example, a secondary battery, such as a lithium ion battery and a nickel-metal hydride battery. The voltage of the electrical storage device 300 is, for example, about 200 V. The electrical storage device 300 not only stores electric power that is output from the rectifying unit 200 but also stores electric power that is generated by the power generating device 400. The electrical storage device 300 supplies the stored electric power to the power generating device 400. A large-capacitance capacitor may also be employed as the electrical storage device 300. Although not specifically shown in the drawing, a DC-DC converter that adjusts the output voltage of the rectifying unit 200 may be provided between the rectifying unit 200 and the electrical storage device 300.

The power generating device 400 generates driving force for propelling the vehicle 10 by using electric power that is stored in the electrical storage device 300. Although not specifically shown in the drawing, the power generating device 400, for example, includes an inverter, a motor, drive wheels, and the like. The inverter receives electric power from the electrical storage device 300. The motor is driven by the inverter. The drive wheels are driven by the motor. The power generating device 400 may include a generator and an engine. The generator is used to charge the electrical storage device 300. The engine is able to drive the generator.

The vehicle ECU 500 includes a central processing unit (CPU), a storage device, an input/output buffer, and the like (all of which are not shown). The vehicle ECU 500 receives signals input from various sensors or outputs control signals to various devices, and controls the devices in the vehicle 10. As an example, the vehicle ECU 500 executes traveling control over the vehicle 10 and charging control over the electrical storage device 300. These controls are not limited to software processing, and may be processed by exclusive hardware (electronic circuit).

A relay 210 is provided between the rectifying unit 200 and the electrical storage device 300. The relay 210 is turned on by the vehicle ECU 500 when the electrical storage device 300 is charged from the power transmitting device 90. A system main relay (SMR) 310 is provided between the electrical storage device 300 and the power generating device 400. The SMR 310 is turned on by the vehicle ECU 500 when start-up of the power generating device 400 is required.

In addition, a relay 202 is provided between the rectifying unit 200 and the relay 210. A voltage VR between both ends of a resistor 201 connected in series with the relay 202 is detected by a voltage sensor 203, and is transmitted to the vehicle ECU 500.

When the electrical storage device 300 is charged from the power transmitting device 90, the vehicle ECU 500 communicates with the communication unit 810 of the power transmitting device 90 by using the communication unit 510, and exchanges information about start/stop of charging, a power receiving condition of the vehicle 10, and the like, with the power supply ECU 800.

The power supply unit 600 receives electric power from the external power supply 900, such as a commercial system power supply, and generates alternating-current power having a predetermined transmission frequency.

The power transmitting unit 700 includes primary coils for contactlessly transmitting electric power to the power receiving unit 100. The power transmitting unit 700 receives alternating-current power having the transmission frequency from the power supply unit 600, and contactlessly transmits electric power to the power receiving unit 100 of the vehicle 10 via an electromagnetic field that is generated around the power transmitting unit 700.

The filter circuit 610 is provided between the power supply unit 600 and the power transmitting unit 700, and suppresses harmonic noise that arises from the power supply unit 600. The filter circuit 610 is formed of an LC filter including an inductor and a capacitor.

The power supply ECU 800 includes a CPU, a storage device, an input/output buffer, and the like (all of which are not shown). The power supply ECU 800 receives signals input from various sensors or outputs control signals to various devices, and controls the devices in the power transmitting device 90. As an example, the power supply ECU 800 executes switching control over the power supply unit 600 so that the power supply unit 600 generates alternating-current power having the transmission frequency. These controls are not limited to software processing, and may be processed by exclusive hardware (electronic circuit).

When electric power is transferred to the vehicle 10, the power supply ECU 800 communicates with the communication unit 510 of the vehicle 10 by using the communication unit 810, and exchanges information about start/Stop of charging, a power receiving condition of the vehicle 10, and the like, with the vehicle 10.

Alternating-current power having the predetermined transmission frequency is supplied from the power supply unit 600 to the power transmitting unit 700 via the filter circuit 610. The power transmitting unit 700 and the power receiving unit 100 of the vehicle 10 each include a coil and a capacitor, and are designed to resonate at the transmission frequency. A Q value indicating the resonant strength of the power transmitting unit 700 and power receiving unit 100 is desirably higher than or equal to 100.

When alternating-current power is supplied from the power supply unit 600 to the power transmitting unit 700 via the filter circuit 610, energy (electric power) is transferred from the power transmitting unit 700 to the power receiving unit 100 through an electromagnetic field that is formed between the primary coils of the power transmitting unit 700 and the secondary coil of the power receiving unit 100. Energy (electric power) transferred to the power receiving unit 100 is supplied to the electrical storage device 300 via the filter circuit 150 and the rectifying unit 200.

Although not particularly shown in the drawing, in the power transmitting device 90, an isolation transformer may be provided between the power transmitting unit 700 and the power supply unit 600 (for example, between the power transmitting unit 700 and the filter circuit 610). In the vehicle 10 as well, an isolation transformer may be provided between the power receiving unit 100 and the rectifying unit 200 (for example, between the power receiving unit 100 and the filter circuit 150).

Next, various coil types of vehicles will be described. FIG. 2 is a view that shows a first coil-type (solenoid) coil that is used in the power receiving unit that is mounted on a vehicle. FIG. 3 is a view that shows a second coil-type (DD) coil that is used in the power receiving unit that is mounted on a vehicle. FIG. 4 is a view that shows a third coil-type (spiral) coil that is used in the power receiving unit that is mounted on a vehicle. FIG. 2 to FIG. 4 are views from the side facing the power transmitting device (usually, lower side) when mounted on a vehicle, and the positive direction of a Z axis is actually a vertically upward direction when mounted on a vehicle.

As shown in FIG. 2, a power receiving unit 100A includes a first coil-type (solenoid) coil 102A and a magnetic material 101A. In the first coil-type (solenoid) coil 102A, a coil wire is wound so as to surround a winding axis OA extending in the horizontal direction. The coil 102A is wound around the magnetic material 101A. The magnetic material 101A has a rectangular plate shape.

As shown in FIG. 3, a power receiving unit 100B includes a second coil-type (DD) coil and a magnetic material 101B. In the second coil-type (DD) coil, two coils 102B, 103B are arranged side by side in the horizontal direction. In each of the two coils 102B, 103B, a coil wire is wound so as to surround a corresponding one of vertical winding axes OB1, OB2. The magnetic material 101B is arranged on the back faces of the coils 102B, 103B.

As shown in FIG. 4, a power receiving unit 100C includes a third coil-type (spiral) coil 102C and a magnetic material 101C. In the third coil-type (spiral) coil 102C, a coil wire is wound so as to surround a winding axis OC extending in the vertical direction. The magnetic material 101C is arranged on the back face of the coil 102C.

There is a possibility that a power receiving unit including any one of the coil-type coils shown in FIG. 2 to FIG. 4 is mounted on a vehicle. Thus, a power transmitting device that is installed at a parking lot in a public place is desirably adaptable to such various coil types. It is possible to adapt to various coil types by devising the configuration of the coils of the power transmitting unit of the power transmitting device.

FIG. 5 is a view for illustrating the configuration of the coils of the power transmitting unit 700 of the power transmitting device. As shown in FIG. 5, the power transmitting unit 700 includes a plurality of power transmitting coils 701 to 706 and a magnetic material 710. In each of the plurality of power transmitting coils 701 to 706, a coil wire is wound so as to surround a corresponding one of winding axes O71 to O76 extending in the vertical direction. The plurality of power transmitting coils 701 to 706 are arranged in the vehicle traveling direction or vehicle width direction of the parking space. The magnetic material 710 is arranged on the back faces of the power transmitting coils 701 to 706.

The orientation of the Z axis in FIG. 5 is opposite to those of FIG. 2 to FIG. 4. FIG. 2 to FIG. 4 are views from the bottom face of a vehicle, whereas FIG. 5 is a view from the upper side toward the ground surface.

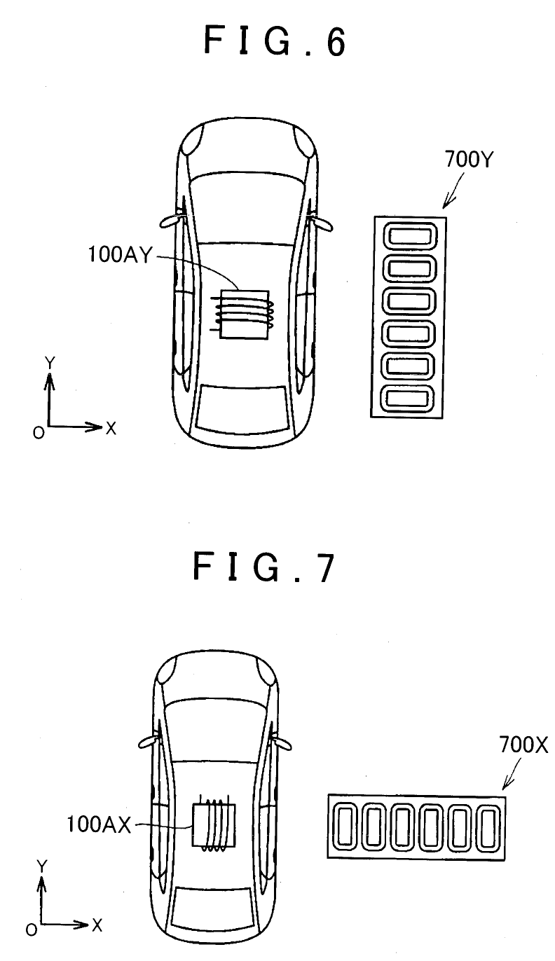

Next, a relationship between a direction in which the vehicle-side power receiving unit is arranged and a direction in which the power transmitting unit is arranged will be described. FIG. 6 is a view that shows an example in which a solenoid coil 100AY is arranged such that the direction of passage of a magnetic flux coincides with the traveling direction of the vehicle (oriented in a Y direction), and that shows arrangement of a power transmitting unit 700Y that adapts to the solenoid coil 100AY.

FIG. 7 is a view that shows an example in which a solenoid coil 100AX is arranged such that the direction of passage of a magnetic flux intersects with the traveling direction of the vehicle at right angles (oriented in an X direction), and that shows arrangement of a power transmitting unit 700X that adapts to the solenoid coil 100AX.

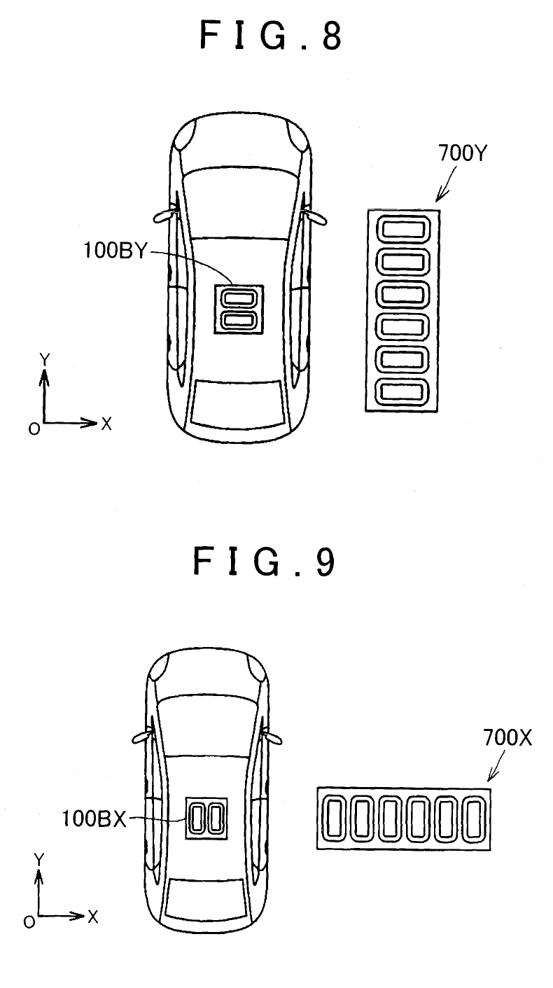

FIG. 8 is a view that shows an example in which a DD coil 100BY is arranged such that an array direction of two coils coincides with the traveling direction of the vehicle (oriented in the Y direction), and that shows arrangement of the power transmitting unit 700Y that adapts to the DD coil 100BY.

FIG. 9 is a view that shows an example in which a DD coil 100BX is arranged such that an array direction of two coils intersects with the traveling direction of the vehicle at right angles (oriented in the X direction), and that shows arrangement of the power transmitting unit 700X that adapts to the DD coil 100BX.

Although the power transmitting unit 700 may be arranged such that the longitudinal direction is oriented in a direction that intersects with the vehicle traveling direction at right angles as shown in FIG. 7 and FIG. 9, hereinafter, an example in which the power transmitting unit 700 is arranged such that the longitudinal direction is oriented in the vehicle traveling direction as shown in FIG. 6 and FIG. 8 will be typically described.

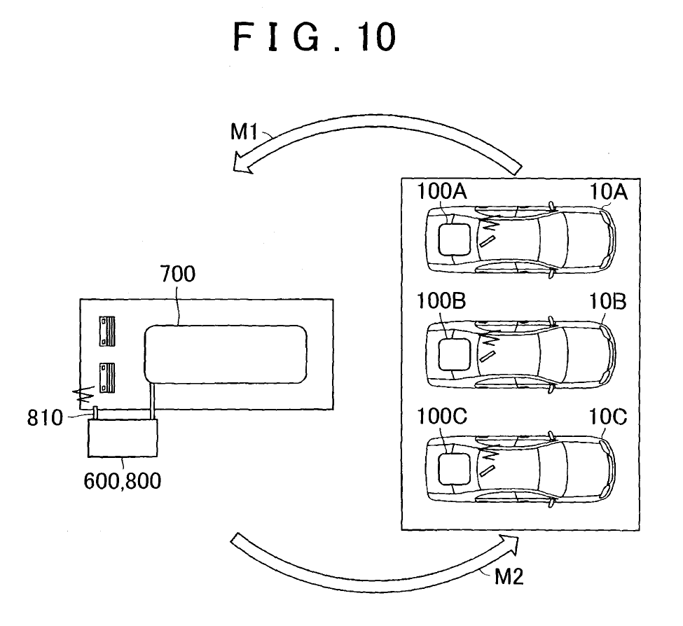

FIG. 10 is a view for illustrating communication about the coil type of a vehicle. As shown in FIG. 10, a vehicle 10A is a vehicle on which the power receiving unit 100A shown in FIG. 2 is mounted. A vehicle 10B is a vehicle on which the power receiving unit 100B shown in FIG. 3 is mounted. A vehicle 10C is a vehicle on which the power receiving unit 100C shown in FIG. 4 is mounted.

Each of the vehicles 10A, 10B, 10C transmits a message M1 to the communication unit 810 of the power transmitting device. The message M1 includes which type of coil is mounted on the host vehicle.

Based on the message M1 transmitted from the vehicle side, it is determined whether the vehicle is chargeable from the power transmitting device, and a message M2 indicating the determined result is transmitted back to the vehicle. At the same time, in the power transmitting unit 700 of the power transmitting device, coils to be used are selected from among the plurality of coils.

FIG. 11 is a view for illustrating selection of coils and directions of currents in the coils in the power transmitting unit 700 in the case where the power transmitting unit 700 is adapted to the power receiving unit 100A (solenoid type). Any one of coil pairs CP1 to CP5 is selected and used. The coil pairs CP1 to CP5 are pairs of adjacent coils in the power transmitting unit 700. In the example of FIG. 11, the coil pair CP3 of coil 703 and coil 704 is selected in accordance with the position of the power receiving unit 100A of the vehicle, and the directions of currents are determined such that the directions in which magnetic fluxes are respectively generated in the coil 703 and the coil 704 are opposite to each other as indicated by the arrows. The coils 701 to 706 are schematically shown, but actually each of the coils 701 to 706 is wound as shown in FIG. 5 (the same applies to the following drawings).

FIG. 12 is a view for illustrating selection of coils and directions of currents in the coils in the power transmitting unit 700 in the case where the power transmitting unit 700 is adapted to the power receiving unit 100B (DD type). In the example of FIG. 12, the coil pair CP3 of coil 703 and coil 704 is selected in accordance with the position of the power receiving unit 100B of the vehicle, and the directions of currents are determined such that the directions in which magnetic fluxes are respectively generated in the coil 703 and the coil 704 are opposite to each other as indicated by the arrows. Between the example of FIG. 12 and the example of FIG. 11, selection of coils and directions of currents are the same.

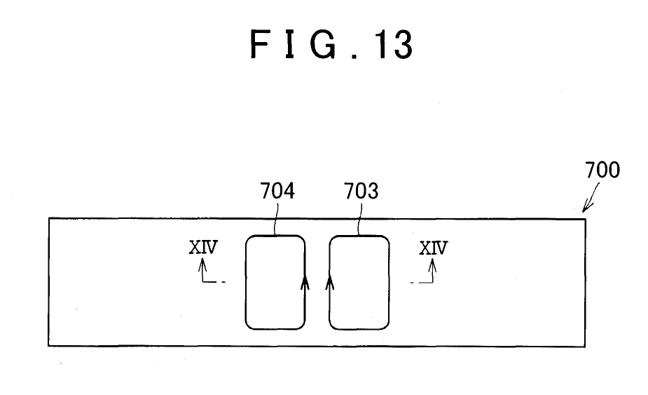

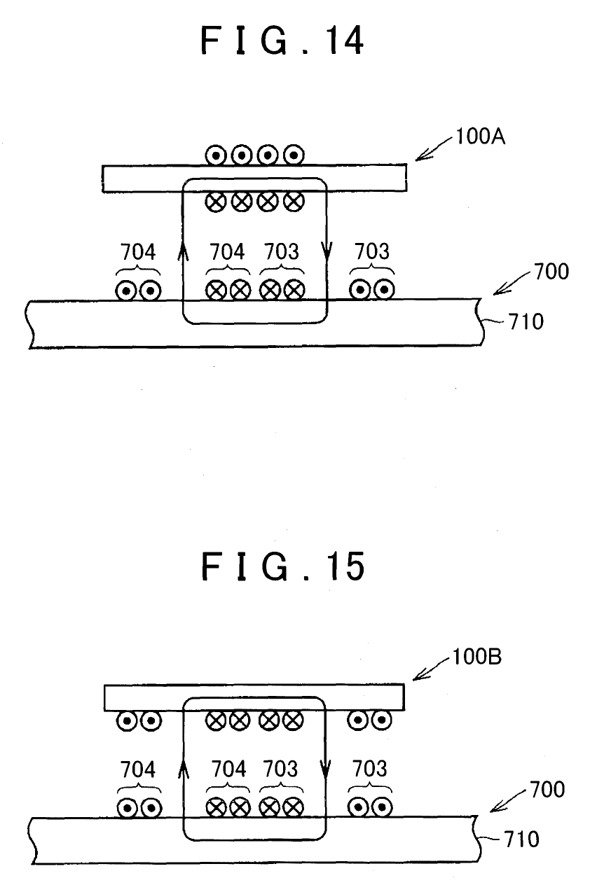

FIG. 13 is a plan view (schematic view) of the coils in the power transmitting unit 700. FIG. 14 is a cross-sectional view taken along the line XIV-XIV in FIG. 13 in a state where the position of the power receiving unit 100A is aligned with the position of the power transmitting unit 700. FIG. 15 is a cross-sectional view taken along the line XIV-XIV in FIG. 13 in a state where the position of the power receiving unit 100B is aligned with the position of the power transmitting unit 700. Both in FIG. 14 and in FIG. 15, a magnetic flux as indicated by the arrow is generated.

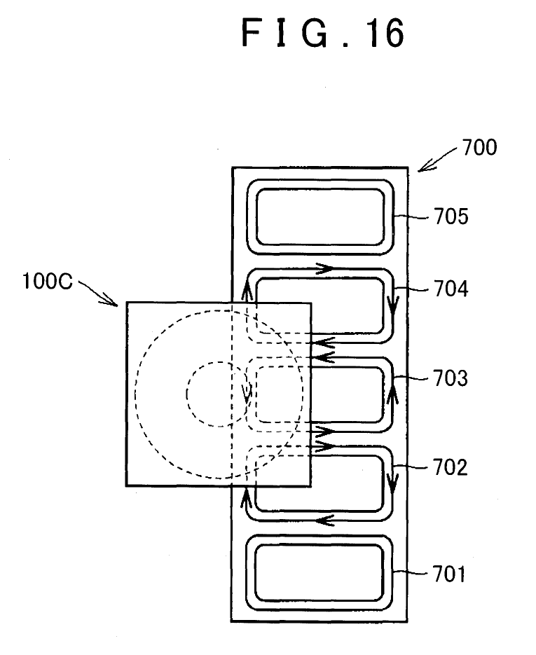

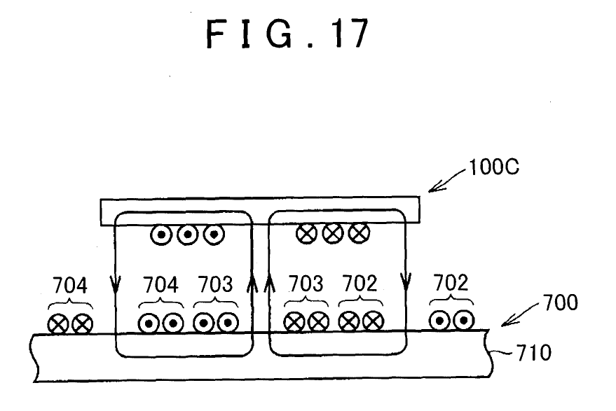

FIG. 16 is a view for illustrating selection of coils and directions of currents in the coils in the power transmitting unit 700 in the case where the power transmitting unit 700 is adapted to the power receiving unit 100C (spiral type). FIG. 17 is a cross-sectional view that shows a state where magnetic fluxes are generated in the case where the position of coil is aligned at the position shown in FIG. 16.

As shown in FIG. 16, the coils 702, 703, 704 are selected, and currents are respectively passed through the coils 702, 703, 704. Currents are respectively passed through the coils 702, 704 in the same direction, and a current is passed through the coil 703 in the opposite direction, with the result that magnetic fluxes as indicated by the arrows in FIG. 17 are generated. A current does not necessarily need to be passed through the coil 703.

As described above, by appropriately selecting coils in the power transmitting unit 700 and controlling directions of currents that are respectively passed through the coils, it is possible to adapt the power transmitting unit 700 to the plurality of coil types.

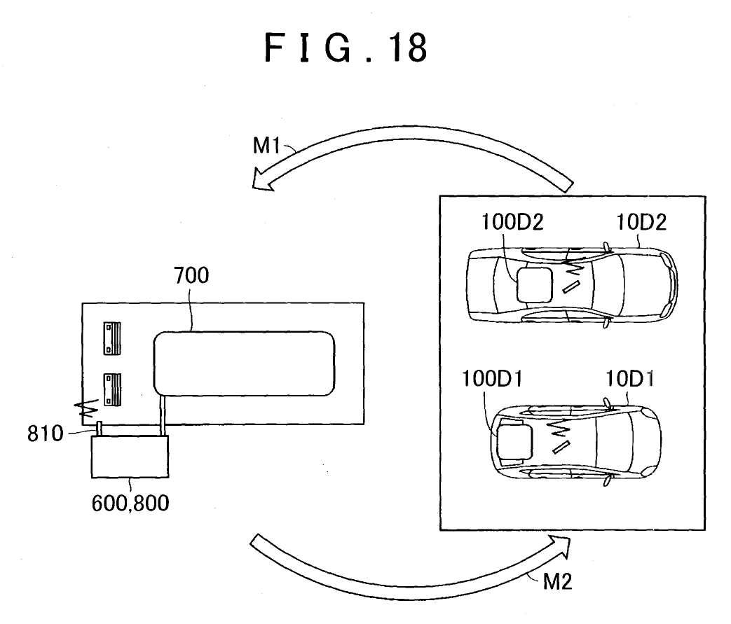

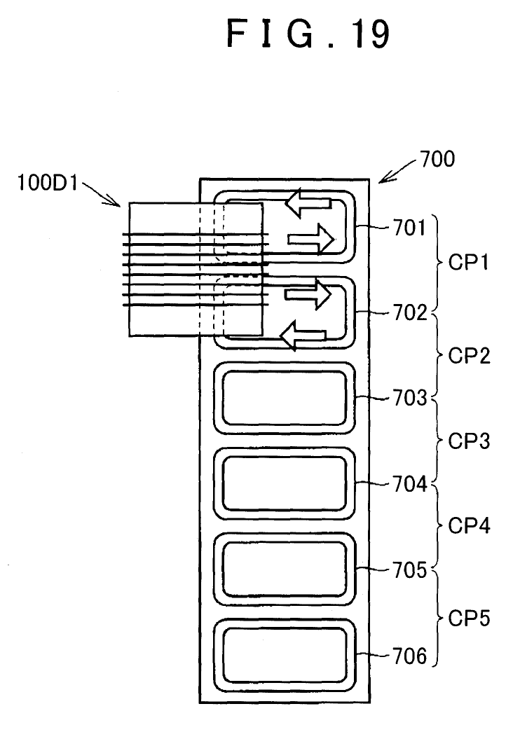

Next, adjustment for a coil mounting position will be described. FIG. 18 is a view for illustrating communication about the position of a coil that is mounted on a vehicle.

As shown in FIG. 18, a vehicle 10D1 is a vehicle on which a power receiving coil 100D 1 is mounted at a rear portion. A vehicle 10D2 is a vehicle on which a power receiving coil 100D2 is mounted at a portion closer to the center than the rear portion.

Each of the vehicles 10D1, 10D2 transmits a message M1 to the communication unit 810 of the power transmitting device. The message M1 includes what position the coil mounting position of the host vehicle is.

Based on the message M1 transmitted from the vehicle side, it is determined whether the vehicle is chargeable from the power transmitting device, and a message M2 indicating the determined result is transmitted back to the vehicle. At the same time, in the power transmitting unit 700 of the power transmitting device, coils to be used are selected from among the plurality of coils.

FIG. 19 is a view that shows a state where the position of the power receiving coil 100D1 shown in FIG. 18 is aligned with the position of the power transmitting unit 700. FIG. 20 is a view that shows a state where the position of the power receiving coil 100D2 shown in FIG. 18 is aligned with the position of the power transmitting unit 700.

When the power receiving coil 100D1 that is arranged at the rear portion of the vehicle 10D1 is the power transmitted target as shown in FIG. 19, the coil pair CP1 that is the pair of coils 701, 702 is selected, and currents flow as indicated by the arrows.

When the power receiving coil 100D2 that is arranged at a position closer to the center than the rear portion of the vehicle 10D2 is the power transmitted target as shown in FIG. 20, the coil pair CP2 that is the pair of coils 702, 703 is selected, and currents flow as indicated by the arrows.

In any of the cases shown in FIG. 19 and FIG. 20, adjacent coils are selected, and currents are respectively passed through the selected coils such that the direction of a magnetic flux that is generated in one of the coils is opposite to the direction of a magnetic flux that is generated in the other one of the coils.

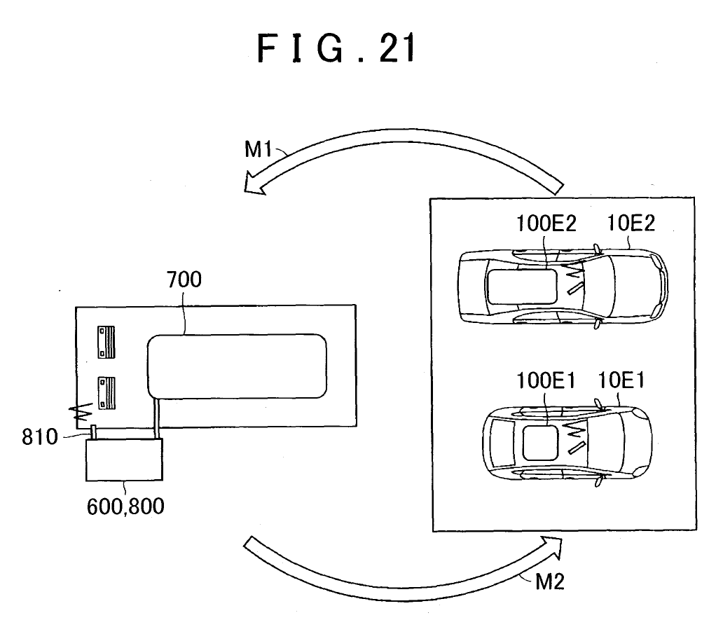

Next, adjustment for the size of a coil will be described. FIG. 21 is a view for illustrating communication about the size of a coil that is mounted on a vehicle.

As shown in FIG. 21, a vehicle 10E1 is a vehicle on which a power receiving coil 100E1 is mounted at a center portion. A vehicle 10E2 is a vehicle on which a power receiving coil 100E2 larger than the power receiving coil 100E1 is mounted at the center portion.

Each of the vehicles 10E1, 10E2 transmits a message M1 to the communication unit 810 of the power transmitting device. The message M1 includes the size of the coil of the host vehicle and the coil mounting position.

Based on the message M1 transmitted from the vehicle side, it is determined whether the vehicle is chargeable from the power transmitting device, and a message M2 indicating the determined result is transmitted back to the vehicle. At the same time, in the power transmitting unit 700 of the power transmitting device, coils to be used are selected from among the plurality of coils.

FIG. 22 is a view that shows a state where the position of the power receiving coil 100E1 shown in FIG. 21 is aligned with the position of the power transmitting unit 700. FIG. 23 is a view that shows a state where the position of the power receiving coil 100E2 shown in FIG. 21 is aligned with the position of the power transmitting unit 700.

When the power receiving coil 100E1 that is arranged at the center portion of the vehicle 10E1 is the power transmitted target as shown in FIG. 22, the coil pair CP3 that is the pair of coils 703, 704 is selected, and currents flow as indicated by the arrows.

When the power receiving coil 100E2 larger than the power receiving coil 100E1 is the power transmitted target as shown in FIG. 23, the coil pair CP13 that is the pair of coils 703, 705 is selected, and currents flow as indicated by the arrows.

In the case of FIG. 22, any one of the coil pairs CP1 to CP5, each of which is formed of adjacent coils, is selected in accordance with a mounting position, and currents are passed such that the direction of a magnetic flux that is generated in one of the coils is opposite to the direction of a magnetic flux that is generated in the other one of the coils.

In contrast, in the case of FIG. 23, any one of coil pairs CP11 to CP14, each of which is formed of two coils that are adjacent but one, is selected in accordance with a mounting position, and currents are passed such that the direction of a magnetic flux that is generated in one of the coils is opposite to the direction of a magnetic flux that is generated in the other one of the coils. When the size of the vehicle-side coil is further large, a coil pair that is formed of two coils that are adjacent but two or more may be used. In this way, it is possible to configure the power transmitting device that adapts to the size of the power receiving coil by adjusting the distance between the selected two power transmitting coils.

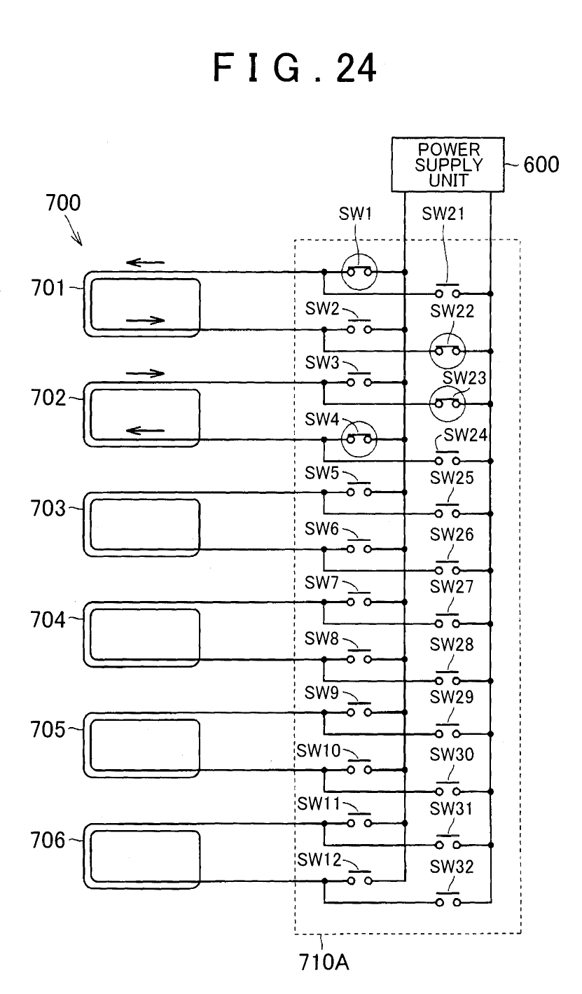

Next, the configuration of a coil selection unit will be described. FIG. 24 is a circuit diagram that shows a first configuration example of a coil selection unit of the power transmitting unit 700. As shown in FIG. 24, the coil selection unit 710A is provided between the coil 701 and the power supply unit 600, and is configured to be able to select any two of the coils and invert the directions of currents respectively flowing through the any two of the coils. The filter circuit 610 shown in FIG. 1 is provided at any one of the power supply unit 600 side or the coils 701 to 706 side; however, the filter circuit 610 is not shown here.

The coil selection unit 710A includes switches SW1, SW3, SW5, SW7, SW9, SW11, and switches SW2, SW4, SW6, SW8, SW10, SW12. Each of the switches SW1, SW3, SW5, SW7, SW9, SW11 is used to selectively connect one end of a corresponding one of the coils 701 to 706 to a first power supply line of the power supply unit 600. Each of the switches SW2, SW4, SW6, SW8, SW10, SW12 is used to selectively connect the other end of a corresponding one of the coils 701 to 706 to the first power supply line of the power supply unit 600.

The coil selection unit 710A further includes switches SW21, SW23, SW25, SW27, SW29, SW31, and switches SW22, SW24, SW26, SW28, SW30, SW32. Each of the switches SW21, SW23, SW25, SW27, SW29, SW31 is used to selectively connect one end of a corresponding one of the coils 701 to 706 to a second power supply line of the power supply unit 600. Each of the switches SW22, SW24, SW26, SW28, SW30, SW32 is used to selectively connect the other end of a corresponding one of the coils 701 to 706 to the second power supply line of the power supply unit 600.

As shown in FIG. 24, in the coil selection unit 710A, the switches SW1, SW4, SW22, SW23 are set in an on state, and the other switches are set in an off state. As a result, the coils 701, 702 are selected, and currents flow in the directions indicated by the arrows.

With employment of the above configuration, it is possible to supply electric power to various vehicles by selecting two from among the switches SW1 to SW12 and two from the switches SW21 to SW32, setting the selected switches in the on state and setting the other switches in the off state in accordance with the mounting position, size and coil type of the vehicle-side coil.

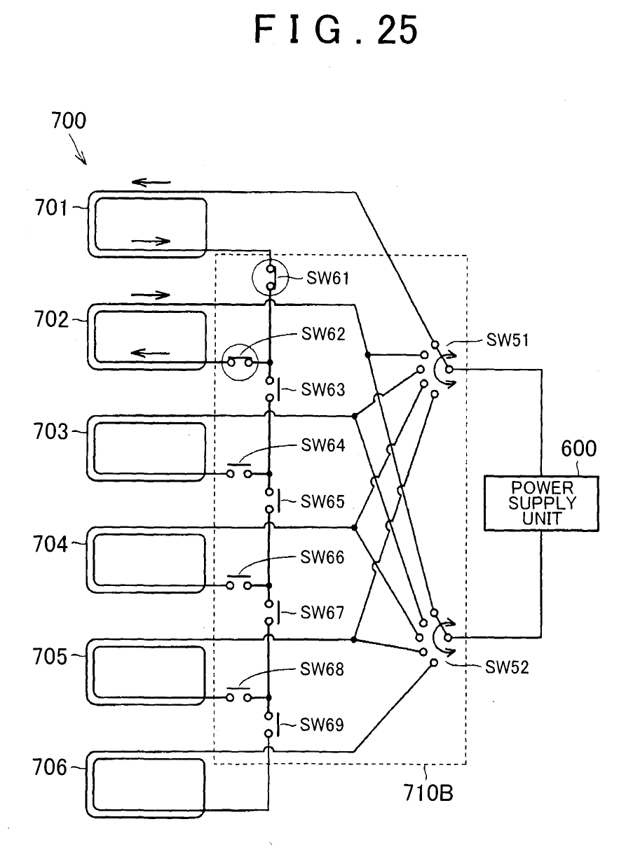

FIG. 25 is a circuit diagram that shows a second configuration example of a coil selection unit of the power transmitting unit 700. As shown in FIG. 25, the coil selection unit 710B is provided between the coil 701 and the power supply unit 600, and is configured to be able to select any two of the coils and invert the directions of currents respectively flowing through the any two of the coils. The filter circuit 610 shown in FIG. 1 is provided at any one of the power supply unit 600 side or the coils 701 to 706 side; however, the filter circuit 610 is not shown here.

The coil selection unit 710B includes a switch SW51 and a switch SW52. The switch SW51 is used to selectively connect any one of one ends of the coils 701 to 705 to the first power supply line of the power supply unit 600. The switch SW52 is used to selectively connect any one of the other ends of the coils 702 to 706 to the second power supply line of the power supply unit 600.

The coil selection unit 710B further includes switches SW61, SW62, SW63, SW64, SW65, SW66, SW67, SW68, SW69. The switches SW61, SW62 establish a route that connects one end of the coil 701 to the other end of the coil 702. The switches S62, SW63, SW64 establish a route that connects one end of the coil 702 to the other end of the coil 703. The switches S64, SW65, SW66 establish a route that connects one end of the coil 703 to the other end of the coil 704. The switches S66, SW67, SW68 establish a route that connects one end of the coil 704 to the other end of the coil 705. The switch S68, SW69 establish a route that connects one end of the coil 705 to the other end of the coil 706.

As shown in FIG. 25, in the coil selection unit 710B, the switch SW51 selects the coil 701, the switch SW52 selects the coil 702, the switches SW61, SW62 are set in an on state, and the other switches are set in an off state. As a result, the coils 701, 702 are selected, and currents flow in the directions indicated by the arrows.

With employment of the above configuration, it is possible to supply electric power to various vehicles by selecting coils with the use of the switches SW51, SW52 and appropriately conducting the switches SW61 to SW69 in accordance with the mounting position, size and coil type of the vehicle-side coil.

The configuration of FIG. 25 differs from that of FIG. 24 in which two coils are connected to the power supply in parallel in that two coils are connected in series and a current flows through the two coils. The configuration of the coil selection unit is not limited to the configuration of FIG. 24 or the configuration of FIG. 25, and may be variously modified.

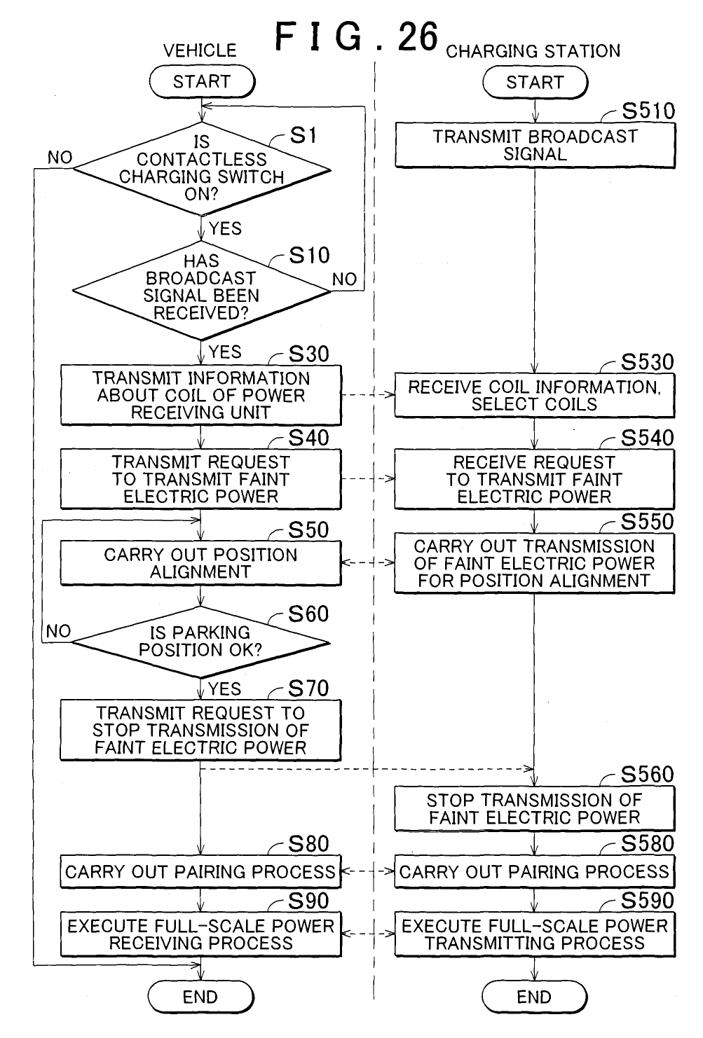

Next, the procedure of contactless power transfer will be described. FIG. 26 is a flowchart for illustrating a schematic process that is executed by the vehicle 10 and the power transmitting device 90 at the time when contactless power transfer is carried out.

As shown in FIG. 1 and FIG. 26, in step S510, when the power supply ECU 800 of the power transmitting device 90 determines that at least one of a plurality of parking lots is vacant based on an output from a vehicle detection sensor provided in each parking lot, the power supply ECU 800 transmits a broadcast signal to surroundings. The broadcast signal informs a chargeable situation.

In step S1, the vehicle 10 determines whether the contactless charging switch 130 provided in the vehicle 10 is “ON”. The contactless charging switch 130 is in an “ON” state when not operated by a user, and is in an “OFF” state when operated by the user. When the vehicle detects that the contactless charging switch 130 is “OFF”, the vehicle ends the process. When it is detected that the contactless charging switch 130 is “ON”, the process proceeds to step S10.

In step S10, the vehicle ECU 500 of the vehicle 10 determines whether the broadcast signal has been received from the power transmitting device 90 of a charging station. When it is determined that the broadcast signal has not been received, the process returns to step S1.

When the vehicle 10 determines in step S10 that the broadcast signal has been received, the process proceeds to step S30. In step S30, the vehicle ECU 500 wirelessly transmits coil-related information, such as the coil type, coil position and coil size of the power receiving unit 100, from the communication unit 510 to the power transmitting device 90. In step S530, the communication unit 810 of the power transmitting device 90 receives the coil-related information, and selects coils in the power transmitting unit 700 based on the information received by the power supply ECU 800.

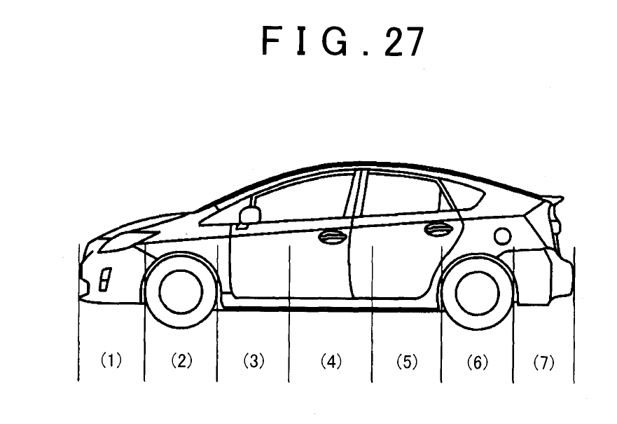

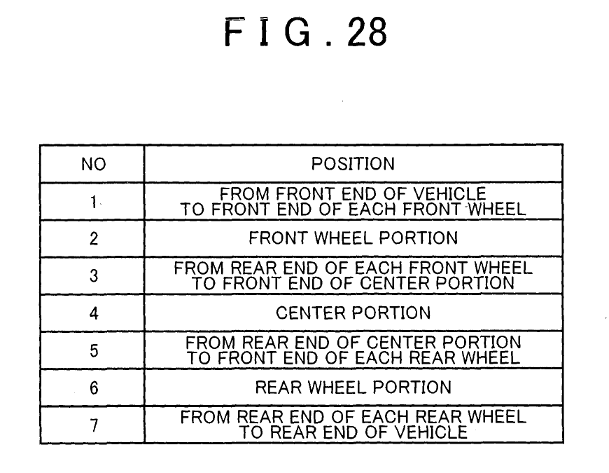

FIG. 27 is a view that shows coil position classes 1 to 7 within the coil-related information. FIG. 28 is a table that shows what positions the coil position classes 1 to 7 respectively indicate.

As shown in FIG. 27 and FIG. 28, the coil position class is any one of the classes 1 to 7. The class 1 indicates that a secondary coil unit is located within a region from the front end of the vehicle 10 to the front end of each front wheel in the horizontal direction. The class 2 indicates that the secondary coil unit is located at a front wheel portion (in a region from the front end of each front wheel to the rear end of each front wheel) in the horizontal direction. The class 3 indicates that the secondary coil unit is located within a region from the rear end of each front wheel to the front end of a center portion in the horizontal direction. The class 4 indicates that the secondary coil unit is located at the center portion (in a region from the front end of the center portion to the rear end of the center portion) in the horizontal direction. The class 5 indicates that the secondary coil unit is located within a region from the rear end of the center portion to the front end of each rear wheel in the horizontal direction. The class 6 indicates that the secondary coil unit is located at a rear wheel portion (in a region from the front end of each rear wheel to the rear end of each rear wheel) in the horizontal direction. The class 7 indicates that the secondary coil unit is located within a region from the rear end of each rear wheel to the rear end of the vehicle 10 in the horizontal direction.

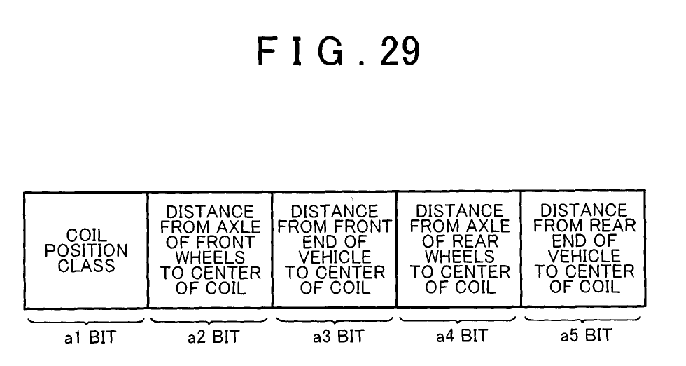

FIG. 29 is a view for illustrating a state where coil-related information is transmitted from the vehicle to the power transmitting device via communication. As shown in FIG. 29, information about the position of the secondary coil unit of the power receiving unit 100 includes the coil position class (any one of the classes 1 to 7 shown in FIG. 27 and FIG. 28) at a1 bit, a distance from the axle of the front wheels to the center of the coil (that is, the secondary coil unit) at a2 bit, a distance from the front end of the vehicle 10 to the center of the coil at a3 bit, a distance from the axle of the rear wheels to the center of the coil at a4 bit, and a distance from the rear end of the vehicle 10 to the center of the coil at a5 bit.

The secondary coil position information is not limited to the one shown in FIG. 29. For example, not all the five pieces of information, shown in FIG. 29, need to be transmitted. In this case, information may be transmitted together with any one of identifiers 1 to 5 that identify information types. The information about the position of the secondary coil unit may be, for example, any one of a combination of the identifier “1” with the coil position class, a combination of the identifier “2” with the distance from the axle of the front wheels to the center of the coil, a combination of the identifier “3” with the distance from the front end of the vehicle 10 to the center of the coil, a combination of the identifier “4” with the distance from the axle of the rear wheels to the center of the coil or a combination of the identifier “5” with the distance from the rear end of the vehicle 10 to the center of the coil.

Referring back to FIG. 26, subsequent to transmission of the coil information in step S30, the vehicle 10 transmits a faint electric power request (small electric power transmission request) to the power transmitting device 90 in step S40.

When the power transmitting device 90 receives the faint electric power request from the vehicle 10 in step S540, the power transmitting device 90 supplies faint electric power to the power transmitting unit 700 in step S550. When no vehicle detection sensor is provided and the power transmitting device 90 includes a plurality of parking lots and a plurality of power transmitting units, the power supply ECU 800 of the power transmitting device 90 cannot recognize at which parking lot the vehicle is about to be parked. Thus, faint electric power is transmitted from all the power transmitting units, which are not carrying out full-scale charging, toward the vehicle.

In step S540, in the power transmitting device 90, a power transmission request from the vehicle is received. In response to this, in the power transmitting device 90, the coils that are selected in the power transmitting unit 700 transmit faint electric power for position alignment with the power receiving device 120 in step S550.

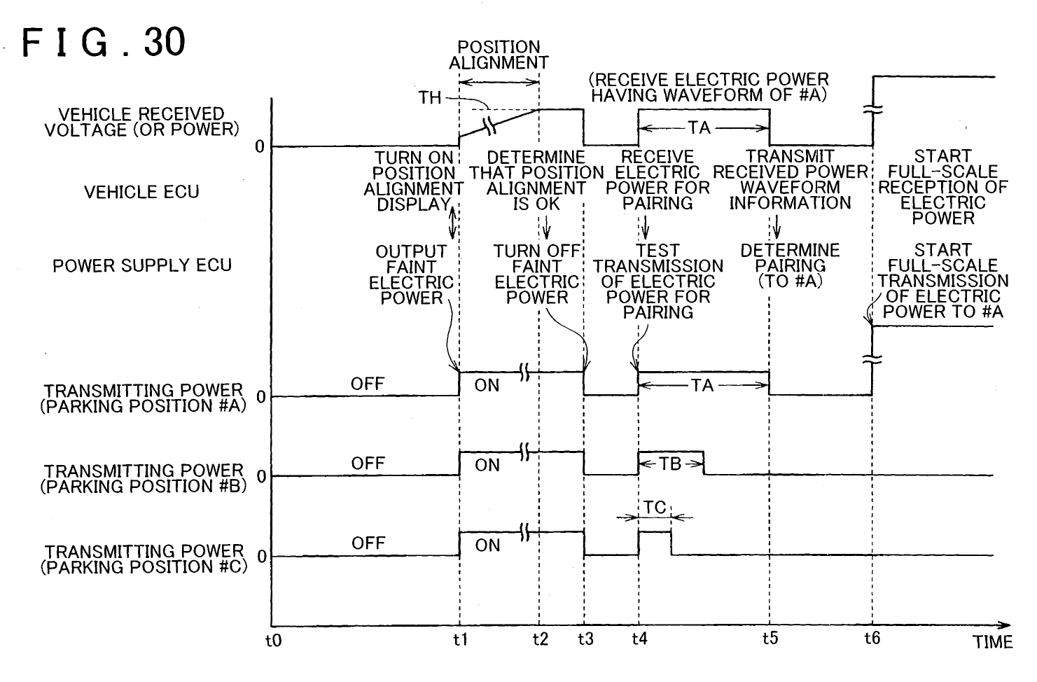

FIG. 30 is a timing chart that shows changes in transmitting power and received voltage in course of the process shown in FIG. 26. As shown in FIG. 1, FIG. 26 and FIG. 30, in step S50, the vehicle 10 carries out position alignment by automatically or manually moving the vehicle 10 (see timing t1 in FIG. 30). In position alignment, the vehicle ECU 500 conducts the relay 202, and acquires the magnitude of received voltage VR that is applied between both ends of the resistor 201 and that is detected by the voltage sensor 203. Because this voltage is lower than that at the time of full-scale transmission of electric power, the vehicle ECU 500 sets the relay 210 in the off state so that transmission of electric power is not influenced by the electrical storage device 300.

When the vehicle 10 moves, a change in the received voltage VR is informed to the user by the display unit 520. Thus, the user recognizes that position alignment is successful. After that, when the user informs that a parking position is OK by pressing a parking switch inside the vehicle 10, the process proceeds to step S70 (see timing t2 in FIG. 30).

In step S70, the vehicle ECU 500 transmits, to the power transmitting device 90, a request to stop transmission of faint electric power for position alignment. In step S560, the power supply ECU 800 of the power transmitting device 90 receives a request to stop transmission of faint electric power, and transmission of faint electric power for position alignment by the power transmitting unit 700 is completed (see timing t3 in FIG. 30).

At this timing, for example, when the power transmitting device 90 includes a plurality of power transmitting units respectively at parking positions #A, #B, #C (for example, charging at a charging station in a place, such as a coin-operated parking), the power supply ECU 800 of the charging station cannot recognize at which parking position the vehicle is about to be parked. Thus, faint electric power is transmitted from all the power transmitting units 700 respectively installed at the currently vacant (not transmitting electric power) parking positions #A, #B, #C.

For a constant primary voltage (output voltage from each of the power transmitting units at the parking positions #A, #B, #C), a secondary voltage (received voltage VR) changes with a distance between the primary coil of the power transmitting unit and the secondary coil of the power receiving device 120. Therefore, a correlation between a received voltage VR and a difference in position in the horizontal direction between the primary coil and the secondary coil is measured in advance, and the received voltage VR for an allowable value of the difference in position in the horizontal direction is set as a threshold TH.

Subsequently, in step S80 and step S580, the vehicle ECU 500 and the power supply ECU 800 execute paring process for identifying which one of the power transmitting units at the parking positions #A, #B, #C the position alignment has been carried out.

The power supply ECU 800 varies the on duration of transmitting power for each power transmitting device. That is, transmitting power is transmitted from the power transmitting unit at the parking position #A for a TA time, transmitting power is transmitted from the power transmitting unit at the parking position #B for a TB time, and transmitting power is transmitted from the power transmitting unit at the parking position #C for a TC time (see timing t4 to timing t5 in FIG. 30).

The vehicle ECU 500 provides notification about the on duration of receiving power to the power supply ECU 800. In the example of FIG. 30, the power receiving unit 100 receives transmitting power from the power transmitting unit at the parking position #A. The vehicle ECU 500 provides, to the power supply ECU 800, notification that the on duration of receiving power is TA. Thus, the power supply ECU 800 recognizes that position alignment with the power transmitting unit at the parking position #A has been carried out.

In step S590, the power transmitting device 90 carries out full-scale power transmitting process by using the power transmitting unit with which position alignment has been carried out and of which identification has been completed through pairing (see timing t6 in FIG. 30). In the example of FIG. 30, the power transmitting unit at the parking position #A carries out power transmitting process. In step S90, the vehicle 10 carries out full-scale power receiving process by using the power receiving device 120, and charges the electrical storage device 300 with received electric power. When charging of the electrical storage device 300 completes, the process of the vehicle side and the process of the power transmitting device end.

As described above, in the present embodiment, in the configuration that a plurality of coils (spiral type) are arranged in line, coil-related information, such as coil type, coil position and coil size, is transmitted from the vehicle 10 to the power transmitting device via communication, and the coils of the power transmitting unit are selected and used in accordance with the configuration of the vehicle, so it is possible to implement a further general power transmitting device.

The invention is not limited to the above-described embodiment. The invention encompasses, for example, the following alternative embodiments.

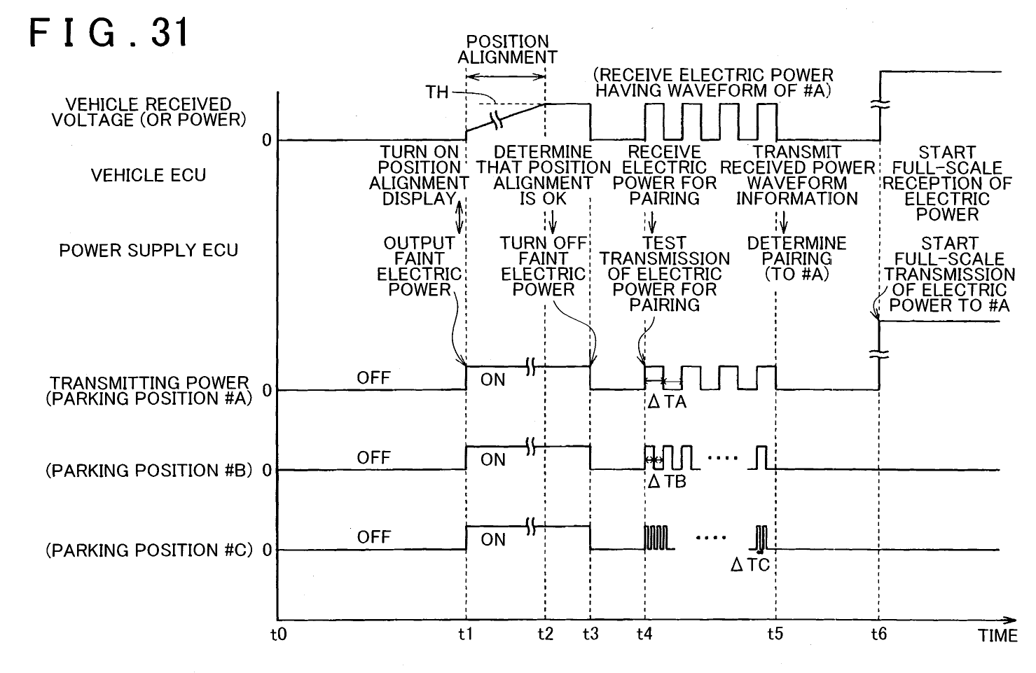

FIG. 31 is a timing chart for illustrating an alternative embodiment of pairing process. As shown in FIG. 1 and FIG. 31, the power supply ECU 800 varies the on/off switching interval of transmitting power for each of the power transmitting units at the parking positions #A to #C. That is, in the power transmitting unit at the parking position #A, transmitting power is switched between an on state and an off state at intervals of a period ΔTA. In the power transmitting unit at the parking position #B, transmitting power is switched between an on state and an off state at intervals of a period ΔTB. In the power transmitting unit at the parking position #C, transmitting power is switched between an on state and an off state at intervals of a period ΔTC (see timing t4 to timing t5 in FIG. 31).

The vehicle ECU 500 provides notification about the on/off switching interval of receiving power to the power supply ECU 800. In the example of FIG. 31, the power receiving device 120 receives transmitting power from the power transmitting unit at the parking position #A. The vehicle ECU 500 provides, to the power supply ECU 800, notification that the on/off switching interval of receiving power is ATA. Thus, the power supply ECU 800 recognizes that position alignment with the power transmitting unit at the parking position #A has been carried out (see timing t5 in FIG. 31).

The alternative embodiment shown in FIG. 31 is an alternative embodiment in which pairing is carried out by using transmitting power; however, pairing is not limited to this configuration. Pairing is possible with various techniques. For example, pairing may be carried out by respectively providing a radio frequency identification (RFID) tag and an RFID reader in a vehicle and each power transmitting unit by the use of an RFID technique.

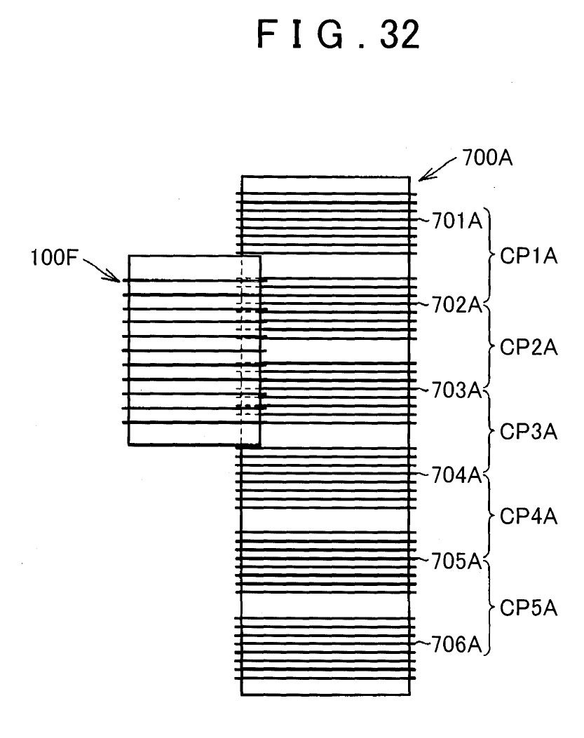

FIG. 32 is a view that shows an alternative embodiment of the power transmitting unit. In the example of the configuration of FIG. 5, the plurality of DD coils are arranged in the power transmitting unit 700. A power transmitting unit 700A in which a plurality of solenoid coils 701A to 706A shown in FIG. 32 are arranged may be provided instead of the power transmitting unit 700. Any one of the coils 701A to 706A may be selected and used alone or any two of the coils 701A to 706A, like CP1A to CP5A, may be selected and used in combination.

In the present embodiment, an example in which the power transmitting unit 700 of the power transmitting device 90 includes the plurality of coils and the power transmitting coil to be used is selected in response to the coil type, coil position and coil size of the vehicle is described. Instead, the configuration of the power transmitting device 90 and the configuration of the vehicle may be interchanged. That is, a power transmitting coil of any one of coil types shown in FIG. 2 to FIG. 4 is provided at the power transmitting device side and the vehicle includes a power receiving unit configured as in the case of the power transmitting coils shown in FIG. 5 or FIG. 32, it is possible to implement the vehicle that is adaptable to various power transmitting devices.

1-11. (canceled)

12. A power transmitting device configured to contactlessly transmit electric power to a vehicle on which a power receiving coil having any one of a plurality of different coil types is mounted, the power transmitting device comprising:
a plurality of power transmitting coils in each of which a coil wire is wound so as to surround a corresponding one of winding axes extending in a vertical direction, the plurality of power transmitting coils being arranged in a vehicle traveling direction or a vehicle width direction of a parking space, the plurality of power transmitting coils being configured to contactlessly transmit electric power to the power receiving coil; and
an electronic control unit configured to control currents that are respectively supplied to the plurality of power transmitting coils, the electronic control unit being configured to receive information of a coil type of the power receiving coil from the vehicle, and the electronic control unit being configured to transmit electric power from the power transmitting coils to the power receiving coil based on the coil type of the power receiving coil.

13. The power transmitting device according to claim 12, wherein
the power receiving coil has the any one of the plurality of different coil types, and
the electronic control unit is configured to select at least two power transmitting coils from among the power transmitting coils based on the coil type of the power receiving coil, and the electronic control unit is configured to set directions of currents respectively flowing through the selected at least two power transmitting coils.

14. The power transmitting device according to claim 13, wherein
the plurality of coil types include a first coil type and a second coil type, the first coil type is configured such that a coil wire is wound so as to surround a winding axis extending in a horizontal direction, the second coil type is configured such that two coils in each of which a coil wire is wound so as to surround a corresponding one of winding axes extending in the vertical direction are arranged side by side in the horizontal direction, and
the electronic control unit is configured to, when the coil type of the power receiving coil of the vehicle that serves as a power transmitted target is the first coil type or the second coil type, pass currents respectively through the selected two power transmitting coils such that directions of magnetic fluxes that are respectively generated at the corresponding winding axes of the selected two power transmitting coils are opposite to each other.

15. The power transmitting device according to claim 13, wherein
the electronic control unit is configured to receive information of a mounting position of the power receiving coil from the vehicle, and the electronic control unit is configured to change the power transmitting coils to be selected in response to the mounting position of the power receiving coil in the vehicle.

16. The power transmitting device according to claim 13, wherein
the electronic control unit is configured to receive information of a size of the power receiving coil from the vehicle, and the electronic control unit is configured to adjust a distance between the two power transmitting coils to be selected in response to the size of the power receiving coil by changing the power transmitting coils to be selected.

17. The power transmitting device according to claim 12, wherein
the power receiving coil is mounted at any one of a plurality of different mounting positions of the vehicle, and
the electronic control unit is configured to receive information of the mounting position of the power receiving coil from the vehicle, and the electronic control unit is configured to select the power transmitting coils in response to the mounting position of the power receiving coil in the vehicle.

18. The power transmitting device according to claim 12, wherein
the power receiving coil of the vehicle is any one of power receiving coils respectively having a plurality of different sizes, and
the electronic control unit is configured to receive information of the size of the power receiving coil from the vehicle, and the electronic control unit is configured to select at least two power transmitting coils from among the plurality of power transmitting coils, the electronic control unit is configured to adjust a distance between the two power transmitting coils to be selected in response to the size of the power receiving coil by changing the power transmitting coils to be selected.

19. A power transfer system configured to contactlessly transmit or receive electric power, the power transfer system comprising:
a vehicle on which a power receiving coil having any one of a plurality of different coil types is mounted; and
a power transmitting device configured to contactlessly transmit electric power to the power receiving coil of the vehicle, the power transmitting device including a plurality of power transmitting coils and an electronic control unit, each of the plurality of power transmitting coils being configured such that a coil wire is wound so as to surround a corresponding one of winding axes extending in a vertical direction, the plurality of power transmitting coils being arranged in a vehicle traveling direction or a vehicle width direction of a parking space, the electronic control unit being configured to control currents that are respectively supplied to the plurality of power transmitting coils,
the electronic control unit being configured to receive information of a coil type of the power receiving coil from the vehicle, and the electronic control unit being configured to select at least two power transmitting coils from among the plurality of power transmitting coils based on the coil type of the power receiving coil, and
the electronic control unit being configured to set directions of currents respectively flowing through the selected at least two power transmitting coils.

20. The power transfer system according to claim 19, wherein
the power receiving coil has the any one of the plurality of different coil types, and
the electronic control unit is configured to select at least two power transmitting coils from among the power transmitting coils based on of the coil type of the power receiving coil and the electronic control unit is configured to set directions of currents respectively flowing through the selected at least two power transmitting coils.

21. The power transfer system according to claim 19, wherein
the power receiving coil is mounted at any one of a plurality of different mounting positions of the vehicle, and
the electronic control unit is configured to receive information of the mounting position of the power receiving coil from the vehicle, and the electronic control unit is configured to select the power transmitting coils in response to the mounting position of the power receiving coil in the vehicle.

22. The power transfer system according to claim 19, wherein
the power receiving coil of the vehicle is any one of power receiving coils respectively having a plurality of different sizes, and
the electronic control unit is configured to select at least two power transmitting coils from among the plurality of power transmitting coils, the electronic control unit is configured to receive information of the size of the power receiving coil from the vehicle, and the electronic control unit is configured to adjust a distance between the two power transmitting coils to be selected in response to the size of the power receiving coil by changing the power transmitting coils to be selected.
